(19) United States
(12) Patent Application Publication
(10) Pub. No.: US 2009/0061815 A1
(43) Pub. Date: Mar. 5, 2009

(54) METHODS AND PLATFORMS FOR REFRESHING A PRE-PAID ACCOUNT UPON DEMAND BY A USER

(76) Inventors: Jerome Myers, Douglasville, GA (US); John Ruckart, Atlanta, GA (US)

Correspondence Address: AT&T Legal Department;Attn: Patent Docketing, Room 2A-207, One AT&T Way, Bedminster, NJ, 07921, US

(21) Appl. No.: 11/845,401

(22) Filed: Aug. 27, 2007

(51) Int. Cl. H04M 17/00; H04M 3/42; H04Q 7/20

(52) U.S. Cl. 455/406; 455/414.1; 455/466

(57) ABSTRACT

Methods and pre-paid platforms are provided to allow a user of a communication device that has a pre-paid account to submit an electronic request for a refresh of the account. The request is presented within a message sent to an address of an entity in control of the account. The entity in control of the account can then select within the message to accept or deny the request for the refresh. The pre-paid platform responds to the selection by either denying the request or by refreshing the account. The pre-paid platform may charge a monetary account for the amount of the refresh that is applied. The request may be for a custom or pre-defined amount. The response by the entity in control may accept a proposed amount or may specify a different amount for the refresh.

### RELATED APPLICATIONS

The present application is related to co-pending U.S. application Ser. No. ______, filed on ______, and entitled METHODS AND PLATFORMS FOR REFRESHING A PRE-PAID ACCOUNT UPON DETECTING THE OCCURRENCE OF A REFRESH TRIGGERING EVENT, which is incorporated by reference herein in its entirety.

### TECHNICAL FIELD

Embodiments are related to pre-paid accounts. More particularly, the embodiments are related to refreshing the pre-paid account upon a user requesting that the pre-paid account be refreshed.

### BACKGROUND

Pre-paid accounts are a popular way to provide communication services including mobile phone usage, long distance calling usage, electronic wallet usage, and the like. With pre-paid accounts, the funds to cover the communication services are placed into an account in advance of the communication services being provided. Upon use of the communication services, the funds are drawn from the account. Upon the account reaching zero, the communication services are no longer available to the user.

Pre-paid accounts may be useful to service providers and users for various reasons. Individuals with credit issues may find it easier to obtain pre-paid services than post-paid services. Service providers may find it beneficial because the risk of not collecting on services that have been provided is essentially eliminated. Parents and employers may especially benefit from pre-paid accounts for communication services being used by their children and employees, respectively, since the risk of the user exceeding a permitted amount of usage is also essentially eliminated.

While pre-paid accounts have many benefits, one drawback is that a potentially burdensome amount of effort is required to replenish the account. Often, the user receives a notice that the amount of usage has reached or is about to reach zero. Where the user is not the entity with the authority to refresh the account, as in the case of children and employees, the user must contact the entity in control to request the refresh. This contact may be through the pre-paid service which further drains the pre-paid account. The entity in control must then contact a pre-paid platform, typically through an interactive voice response system (IVR), to request that the refresh be done. This is an inconvenience to both the user and the entity in control, as the entity in control must be available for contact from the user and the entity in control must make the effort to initiate contact with the pre-paid platform.

### SUMMARY

Embodiments address issues such as these and others by providing a pre-paid platform that receives a request from a user and communicates that request as an electronic message to the entity in control. The entity in control may then respond directly to the electronic message to authorize or deny the request for the refresh. Thus, the user is not required to directly contact the entity in control to request the refresh and the entity in control is not required to initiate the initial contact with the pre-paid platform.

According to various embodiments, a method of pre-payment for communication services includes receiving a request from a first communication device of a first individual to refresh an amount of usage remaining for a communication service. In response to receiving the request, a message is submitted to an address of a second individual, the message specifying that the request has been received. A response to the message that indicates whether to refresh the amount of usage remaining for the communication service is received, and the amount of usage remaining for the communication service is refreshed when the response indicates to do so.

According to various embodiments, a computer readable medium has instructions that perform acts that include receiving a request from a first communication device of a first individual to refresh an amount of usage remaining for a communication service. In response to receiving the request, a message is submitted to an address of a second individual, the message specifying that the request has been received. A response to the message that indicates whether to refresh the amount of usage remaining for the communication service is received, and the amount of usage remaining for the communication service is refreshed when the response indicates to do so.

According to various embodiments, a pre-paid platform includes means for receiving a request from a device to refresh an amount of remaining usage of a communication service and means for sending a message to an address to request a response regarding whether to refresh the amount of usage of the communication service. The pre-paid platform further includes means for receiving a response indicating whether to refresh the amount of usage and means for refreshing the amount of usage when the response indicates to do so.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

FIG. 1 shows an example of an operating environment for various embodiments.

FIG. 2 shows an example of logical operations performed by a pre-paid platform according to various embodiments.

FIG. 3 shows an example of logical operations performed by a communication device of a user with pre-paid service who is requesting a refresh.

FIG. 4 shows an example of logical operations performed by a communication device of a user with control over the pre-paid service for the mobile communication device.

FIG. 5 shows an example of contents of a database of a pre-paid platform according to various embodiments.

### DETAILED DESCRIPTION

Embodiments provide for refreshing of pre-paid accounts for communication services by allowing a user of a communication device to submit a request for a refresh of the pre-paid account and allowing the request to be passed to a device of an entity in control of the pre-paid account to accept or deny the request. In this manner, the user of the communication device with the pre-paid account is not required to directly contact the entity in control of the pre-paid account and the entity in control of the pre-paid account is not required to initiate contact with the pre-paid platform.

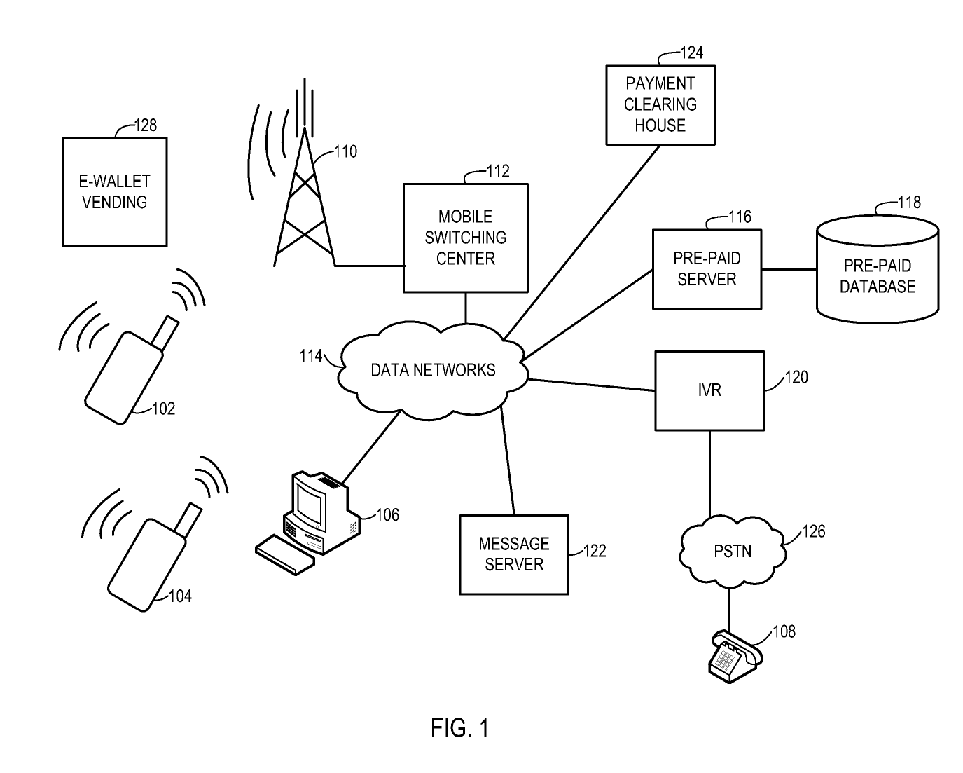

FIG. 1 shows one example of an operating environment for various embodiments for refreshing pre-paid accounts. In this example, communication devices include mobile communication devices such as mobile telephones 102, 104 (e.g., Global System for Mobile Communication (GSM), Personal Communication Service (PCS), Wi-Max) as well as fixed or wireline communication devices 108 (e.g., plain old telephone service (POTS), voice over Internet Protocol (VoIP)). Furthermore, communication services of this example include local, long distance, and/or international voice telephone calls from fixed or mobile communication devices, voice-over Internet Protocol voice telephone calls, text messaging, electronic mail messaging, web browsing, voicemail service, electronic wallet transactions, and the like. For one or more of these services, a platform may be present to administer a pre-paid usage of those one or more communication services and the platform allows the user to submit a request to refresh to the platform. The platform, upon receiving the request, then proceeds to inform an entity in control of the pre-paid account about the request and seek a response from the entity in control to either authorize, modify, or deny the request to refresh.

In this example, the user of the pre-paid account may be operating the mobile communication device 102, a computer system 106 with communication capabilities, the wireline device 108, or any other communication device capable of delivering pre-paid communication service to the user. For example, the user may be participating in voice calls, text messaging such as through a message server 122, web browsing, or other activities through the mobile communication device 102. This device 102 communicates with a mobile communication network to provide such services, where the mobile communication network may include a tower/base station 110 connected to a mobile switching center 112. The mobile switching center 112 may in turn be connected to various data networks 114 including a core network of the mobile communication service, the Internet, private networks, a public switched telephone network (PSTN) 126, and so forth.

As another example, the user may be operating the mobile communication device 102 to employ a pre-paid electronic wallet communication service. Here, the mobile communication device 102 communicates with electronic wallet vending systems 128 to allow the user of the mobile communication device 102 to make purchases of goods and/or services by the mobile communication device 102 providing payment credentials to the vending systems 128.

As yet another example, the user may be operating the computer system 106 that has communication capabilities and that is linked to the data networks 114 such as the Internet and/or private networks. Through the computer system 106, the user may use various pre-paid communication services. For example, the user may place VoIP calls, make dial-up calls to an Internet Service Provider via the PSTN 126, send and receive electronic mail messages and instant messages such as through the message server 122, and the like.

As yet another example, the user may use a fixed communication device, such as the communication device 108, that may be a standard wireline telephone connected to the PSTN 126 to receive pre-paid communication service. For example, the user may make voice calls, check voicemails, and so forth through the fixed communication device 108.

At least one pre-paid platform is present to administer the pre-paid account(s) of the user for the one or more pre-paid communication services being provided to the user. In this example, the pre-paid platform includes a pre-paid server 116 and a pre-paid database 118.

The pre-paid platform may take advantage of various other networks and components present within this illustrative operating environment in order to receive the requests for refreshes and in order to send messages to the entities in control regarding the requests. The pre-paid platform may communicate through the data networks 114 including the core mobile network and the Internet as well as through the PSTN 126. The pre-paid platform may utilize an interactive voice response (IVR) system 120 that is linked to the pre-paid server 116 either directly or through the data network 114 and that is also linked to the PSTN 126 in order to place telephone calls to an address (e.g., telephone number) of the entity in control. The pre-paid platform may utilize the message server 122 to send electronic mail messages or instant messages to an address (e.g., electronic mail or instant message address) of the entity in control.

In anyone of these examples, the user may choose to request a refresh of the remaining usage for the pre-paid account by interacting with a communication device such as the one for which the pre-paid service is applicable. For example, the mobile communication device 102 may allow the user to select a particular menu option for requesting a refresh, or allow the user to dial a specific telephone number or star code that allows the user to submit the request. As another example, the user may be able to visit a particular web page or send an email to a particular email address of the pre-paid platform such as via the computer system 106 in order to submit the refresh request. As yet another example, the user may be able to dial a particular telephone number or star code via the fixed communication device 108 in order to submit the refresh request to the pre-paid platform.

The user may receive notifications from the pre-paid platform regarding depletion of the pre-paid account. For example, the pre-paid platform may monitor the amount of usage remaining in the account and when the amount of usage drops to a certain point, the pre-paid platform may send a notification message to an address of the user, such as placing an automated voice call through the IVR 120, or sending an electronic message such as an electronic mail message, text message, or instant message via the message server 122.

According to exemplary embodiments, the pre-paid server 116 receives the requests from the users of the pre-paid accounts. The pre-paid server 116 may be a conventional server computer system that implements logical instructions such as programming or hard-wired logic to perform the administration of the pre-paid accounts including: generating any notifications to the users, receiving requests for refreshes, submitting messages to entities in control regarding requests for refreshes, receiving responses from the entities in control, and ultimately the refreshing of the pre-paid account. The pre-paid server 116 may access the pre-paid database 118 to store information regarding pre-paid account details and to access information such as when checking for pre-paid account balances, thresholds, and contact information such as the addresses of the users and the entities in control.

The pre-paid server 116, upon receiving authorization from the entities in control, may complete the refresh of the pre-paid accounts by increasing the remaining account usage posted in the pre-paid database 118 by the amount authorized by the entity in control. The pre-paid server 116 then processes an electronic payment transaction via a payment clearinghouse 124. The payment clearinghouse 124 may be a credit card clearinghouse for pre-paid accounts set to charge credit card accounts, may be banks for pre-paid accounts set to charge bank accounts, and so forth.

The entity in control of the pre-paid account may also be using one or more communication devices including all of the types discussed above for the user of the pre-paid account. As one example, the entity in control may carry a mobile communication device, such as the communication device 104, that communicates through base stations 110. The entity in control may utilize the personal computer system 106 as well as the fixed communication devices 108. The pre-paid server 116 may send messages to the entity in control via one or more of these communication devices in order for the entity in control to then respond to the message to accept, modify, or deny the request for a refresh.

The server computers, personal computers, and communication devices shown in FIG. 1 include examples of computer readable media. Computer readable media may store instructions that when performed implement various logical operations. Such computer readable media may include various storage media including electronic, magnetic, and optical storage. Computer readable media may also include communications media, such as wired and wireless connections used to transfer the instructions or send and receive other data messages.

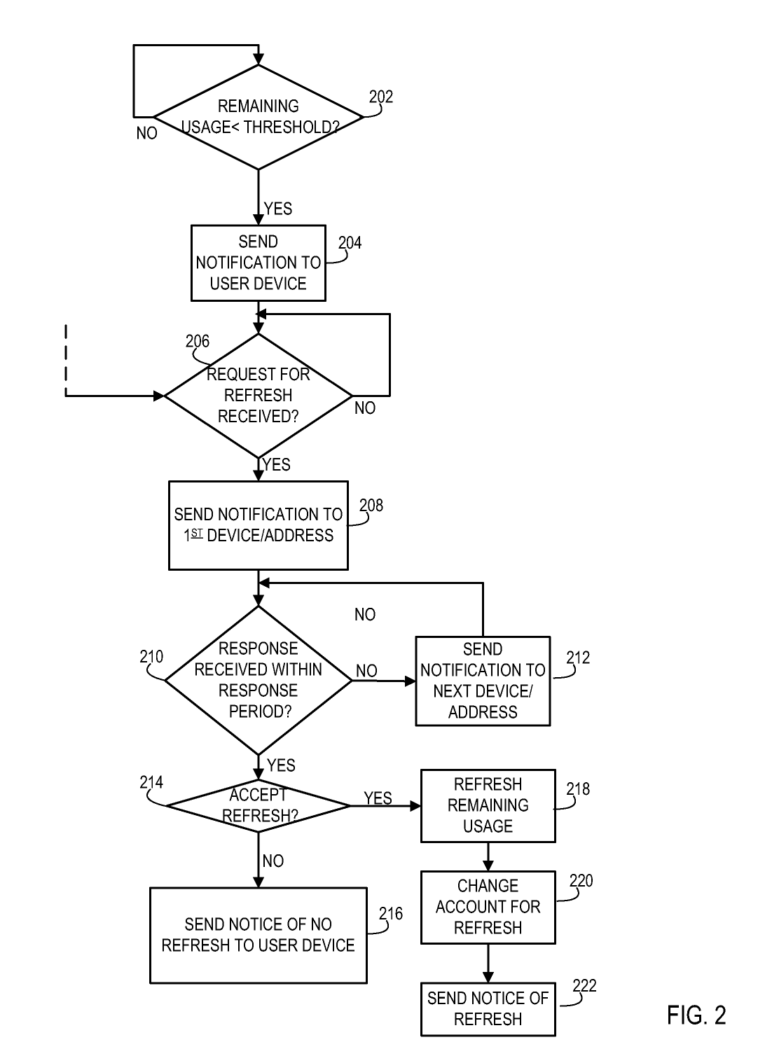

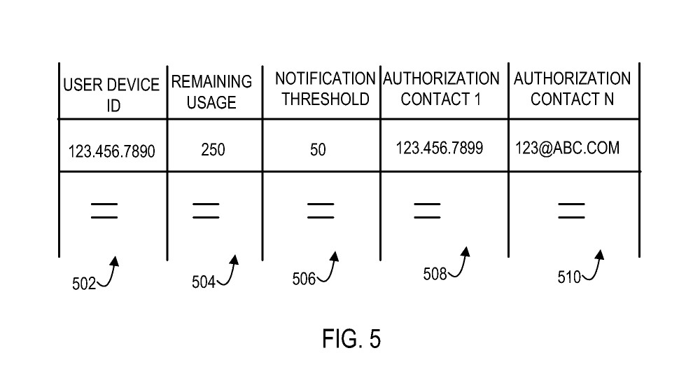

FIG. 2 shows examples of logical operations to be performed by an embodiment of the pre-paid server 116. Two illustrative options are shown. The logical operations of the first option begin at a query operation 202, where the pre-paid server 116 checks the profile for each pre-paid account to determine whether a remaining usage is less than a threshold for the communication service. As discussed in more detail below with reference to FIG. 5, the pre-paid database 118 may maintain the profile for each pre-paid account and may contain the information being used by the pre-paid server 116 such as contact information, usage information, thresholds, and so forth.

Upon determining that a threshold has been reached for a particular user, the pre-paid server 116 then sends a notification to a device address of the user at a notification operation 204. As discussed above, the device address may be a telephone number, electronic mail address, instant message address, text message address, and so forth. Next, at query operation 206, the pre-paid server 116 then detects whether a request for a refresh is received.

The second option provides for the pre-paid server 116 to be monitoring for an incoming request at the query operation 206 regardless of whether a notification has been previously sent to the user. For instance, a user may wish to refresh the remaining usage for the account well before a depletion threshold is met. Furthermore, according to various embodiments, the pre-paid server 116 may not provide such threshold monitoring and related notifications such that it is up to the user to determine when to request a refresh.

The pre-paid server 116 may detect an incoming request for a refresh from a user at the query operation 206 in various ways. For example, the pre-paid server 116 may monitor a particular electronic message account, such as an electronic mail message, text message, or instant message, for an incoming refresh request message. As another example, the pre-paid server 116 may monitor for a notice from a communication network such as the mobile communication network 114 or a node of the PSTN 126 that a user has dialed a refresh telephone number, has dialed a refresh star code, and so forth.

The refresh request that is received may request a default refresh amount according to some embodiments, or may specify a particular amount according to other embodiments. In the case of a default amount, the amount may be specified at the pre-paid account level as part of the account profile or may be specified at the communication service level where the default amount is the same for all pre-paid users of that service. Furthermore, pre-determined amounts may be established, either at the account or service level. A user may specify the pre-determined amount in the request, such as by dialing one star code versus another, or selecting one menu option versus another within the mobile device menu or within an IVR menu. It will be appreciated that the amount being requested for the refresh may be specified in the applicable units for the service (e.g., minutes available, messages available, and so on) and/or may be specified in monetary units.

The pre-paid server 116 then sends a notification message to the device address of the entity in control of the pre-paid account for which the request has been received at a notification operation 208. The delivery of the notification message is in a form appropriate to the device address that is specified. For example, if an electronic message address such as an electronic mail message, text message, or instant message address is provided, then the notification may be delivered as an electronic message via the message server 122 that may be replied to in order to accept, modify by specifying a different refresh amount, or deny the request. If a telephone number is provided, then the notification may be delivered as a voice message via the IVR 120 with prompts to speak or dial numbers to accept, modify, or deny the request.

The pre-paid server 116 monitors for a response to the notification message from the entity in control at a query operation 210. If a response is not received within a response period established for the device address, then the pre-paid server 116 sends a notification to a next device address specified for the pre-paid account, if any, at a notification operation 212.

Upon the pre-paid server 116 receiving a response from the entity in control, the pre-paid server 116 then determines whether the response accepts, modifies, or denies the request for the refresh at a query operation 214. If the response denies the refresh or if no response is received within the response period for all available device addresses, then a notification may be sent to the user device that requested the refresh at a notification operation 216. This notification may inform the user that no refresh has been authorized. The user may then choose to use the service until the remaining usage is fully depleted, wait a while and try a refresh request again, or take other measures such as directly contacting the entity in control to inquire about the denial.

Where the pre-paid server 116 detects that the refresh request has been authorized, either as is or in a modified manner, then the pre-paid server performs the authorized refresh at a refresh operation 218. Here, the pre-paid server 116 increases the remaining usage value for the pre-paid account in accordance with the response. The response may accept the requested amount, or the response may modify the request to authorize a different amount. Where the amount that is authorized is expressed in units applicable to the service and where the pre-paid account stores the remaining usage as units applicable to the service, then those number of units are added to the remaining usage value. Where the amount that is authorized is expressed in monetary units applicable to the service and where the pre-paid account stores the remaining usage as monetary units applicable to the service, then those number of monetary units are added to the remaining usage value. Where the amount that is authorized is one form of units and the remaining usage is stored as the other form of units (e.g., monetary units accepted, minutes remaining are stored as the remaining usage value), then the pre-paid server translates the authorized units to the units stored as the remaining usage value.

The pre-paid server 116 completes the refresh by charging the account a monetary amount corresponding to the authorized increase to the remaining usage at a charge operation 220. Where the response from the entity in control authorized a monetary amount, then that monetary amount is what is charged to the account, along with any other surcharges that may be due for the service. Where the response from the entity in control authorized an amount of units applicable to the service other than a monetary amount, then the pre-paid server translates the authorized amount of units to a monetary amount that is then charged to the account along with any other surcharges that may be due.

After having refreshed the remaining usage of the pre-paid account by the amount authorized by the entity in control, the pre-paid server 116 may then send a notification to the device address of the user that submitted the request at a notification operation 222. The notification may inform the user of the amount of the refresh.

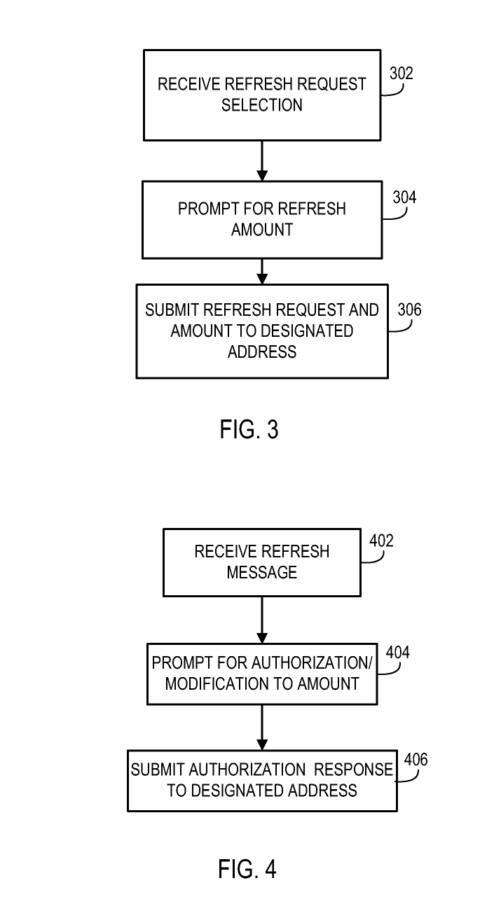

FIG. 3 shows an example of logical operations that may be performed by a communication device of the user. Initially, the communication device receives a refresh request selection at a request operation 302. This may involve the user selecting a refresh option from a menu of a mobile communication device, or dialing a number or star code on a fixed or mobile telephone.

The communication device prompts the user for the refresh amount to request at a prompt operation 304. Here, the prompting may be generated by the communication device being responsive to a menu selection. As another example, the prompting may be generated by the communication device communicating with the pre-paid platform, such as via the IVR 120, and the pre-paid platform initiating the prompt.

The communication device then submits the refresh request and amount to the designated address at a submission operation 306. Here, the submission may be by the communication device automatically submitting an electronic message via the message server 122 in response to the menu selection to refresh or the communication device automatically dialing a particular number or star code in response to the menu selection to refresh. As another example, the submission may be by the communication device receiving verbal or keypad input from the user and returning it to the pre-paid platform, such as via the IVR 120. As this submission is a communication from a communication device of the user that might otherwise be subject to a decrease in the remaining amount of usage for the pre-paid account, the pre-paid platform may be configured to not reduce the remaining amount of usage for this submission.

FIG. 4 shows an example of logical operations that may be performed by a communication device of the entity in control of the pre-paid account. Initially, the communication device receives a refresh message at a message operation 402. The refresh message is sent from the pre-paid server 116 and may be delivered as an electronic message such as an electronic mail message, text message, or instant message, or as a voice message as an incoming telephone call.

The refresh message informs the entity in control about the requested refresh and prompts the entity to respond with an authorization or modification for the requested amount at a prompt operation 404. For example, an electronic mail message may provide a link or active button to select an option to accept, modify, or deny the request. A text message or instant message may instruct the entity to submit a return text or instant message and may instruct the entity about including a code in the return message to accept, modify, or deny the request. As another example, a voice message may instruct the entity in control to either speak a command or dial digits to accept, modify, or deny the request.

Upon the entity in control responding to the message in the instructed manner, the communication device then submits the response to the designated address at a submission operation 406. For example, the communication device may relay the spoken or dialed commands through the in-progress telephone call back to the IVR 120 in communication with the pre-paid server 116. As another example, the communication device may send the electronic message that has been generated in reply to the received electronic message. As this submission is a communication from a communication device that might otherwise be subject to a decrease in a remaining amount of usage for a pre-paid account for the entity in control, the pre-paid platform may be configured to not reduce the remaining amount of usage of that pre-paid account for this submission.

As discussed above, the pre-paid server 116 may rely upon information maintained within the pre-paid database 118 when administering the pre-paid accounts. One example of a structure of the pre-paid database 118 is shown in FIG. 5. In this example, the pre-paid database 118 includes several columns of data. A first column 502 specifies an address for the pre-paid account, such as an identifier of a device of the user where the device is tied to the pre-paid account. For example, the address may be a telephone number of a mobile or fixed communication device. As another example, the address may be an electronic serial number. As another example, where the particular communication device may not be tied to the pre-paid account, the address may be an electronic message address that is distinct from any one device.

A second column 504 specifies a remaining amount of usage for the pre-paid account. This number is decreased by the pre-paid server 116 as the pre-paid communication service is provided. This number is increased by the pre-paid server 116 upon refreshes being authorized by the entity in control.

A third column 506 specifies a notification threshold for this pre-paid account. The notification threshold may be used to determine when to contact the user regarding the remaining usage being depleted down to the threshold. This number may be set by default or may be set by either the entity in control or by the user.

A fourth column 508 specifies a first address for contacting the entity in control to obtain authorization for a refresh. As discussed above for the column 502, this fourth column 508 may contain one of a variety of address types, such as a telephone number, electronic serial number, or electronic message address. Additional column 510 represents one or more additional addresses for contacting the entity in control to obtain authorization for a refresh in case the address of the fourth column 508 fails to achieve a response. This column 510 may also contain one of a variety of address types to supplement the address of column 508.

As discussed above, embodiments provide the user with the ability to request a refresh without directly contacting the entity in control. Likewise, the entity in control can be made aware of the request and can authorize a refresh or deny the request without having to be in direct contact with the user and without having to initiate contact with the pre-paid platform.

While embodiments have been particularly shown and described, it will be understood by those skilled in the art that various other changes in the form and details may be made therein without departing from the spirit and scope of the invention.

What is claimed is:

1. A method of pre-payment for communication services, comprising:
receiving a request from a first communication device of a first individual to refresh an amount of usage remaining for a communication service;
in response to receiving the request, submitting a message to an address of a second individual, the message specifying that the request has been received;
receiving a response to the message that indicates whether to refresh the amount of usage remaining for the communication service; and
refreshing the amount of usage remaining for the communication service when the response indicates to do so.

2. The method of claim 1, further comprising:
determining that the amount of remaining usage for the communication service has decreased to a threshold; and
prior to receiving the request, sending a message to the first communication device to indicate that the threshold has been reached.

3. The method of claim 1, wherein submitting the message to the address comprises sending the message to a second communication device.

4. The method of claim 1, wherein submitting the message to the address comprises sending the message via a text message service.

5. The method of claim 1, wherein submitting the message to the address comprises sending the message to an electronic mail address.

6. The method of claim 1, wherein the communication service is mobile communication service.

7. The method of claim 1, wherein the communication service is long distance service.

8. The method of claim 1, further comprising charging a monetary account upon refreshing the amount of usage remaining.

9. The method of claim 1, further comprising sending a second message to the first communication device to indicate whether the refresh has occurred.

10. A computer readable medium having instructions that perform acts comprising:
receiving a request from a first communication device of a first individual to refresh an amount of usage remaining for a communication service;
in response to receiving the request, submitting a message to an address of a second individual, the message specifying that the request has been received;
receiving a response to the message that indicates whether to refresh the amount of usage remaining for the communication service; and
refreshing the amount of usage remaining for the communication service when the response indicates to do so.

11. The computer readable medium of claim 10, wherein the acts further comprise:
determining that the amount of remaining usage for the communication service has decreased to a threshold; and
prior to receiving the request, sending a message to the first communication device to indicate that the threshold has been reached.

12. The computer readable medium of claim 11, wherein the acts further comprise charging a monetary account upon refreshing the amount of usage remaining.

13. The computer readable medium of claim 11, wherein the acts further comprise sending a second message to the first communication device to indicate whether the refresh has occurred.

14. The computer readable medium of claim 10, wherein the request specifies a value indicative of the amount of refresh of the usage remaining for the communication service and wherein the message specifies the value.

15. The computer readable medium of claim 10, wherein when the response indicates that a refresh should occur, the response further specifies a value indicative of the amount of refresh of the usage remaining for the communication service.

16. A pre-paid platform, comprising:
means for receiving a request from a device to refresh an amount of remaining usage of a communication service,
means for sending a message to an address to request a response regarding whether to refresh the amount of usage of the communication service,
means for receiving a response indicating whether to refresh the amount of usage; and
means for refreshing the amount of usage when the response indicates to do so.

17. The pre-paid platform of claim 16, further comprising means for charging a monetary account upon refreshing the amount of usage remaining.

18. The pre-paid platform of claim 16, further comprising means for sending a second message to the device that submitted the request to indicate whether the refresh has occurred.

19. The pre-paid platform of claim 16, further comprising:
means for presenting a selection of refresh values in the message to the address, wherein the response specifies one of the refresh values; and
means for refreshing the account usage remaining in accordance with the refresh value specified by the response.

20. The pre-paid platform of claim of claim 16, further comprising:
means for maintaining multiple addresses to send messages when a request is received from the device; and
means for sending the message to each of the multiple addresses.
